(19) United States
(12) Patent Application Publication
(10) Pub. No.: US 2025/0120482 A1
(43) Pub. Date: Apr. 17, 2025

(54) Automatic Wheelchair Umbrella Device

(71) Applicant: Dorothy Boyd, Baltimore, MD (US)

(72) Inventor: Dorothy Boyd, Baltimore, MD (US)

(21) Appl. No.: 18/390,760

(22) Filed: Dec. 20, 2023

Related U.S. Application Data
(60) Provisional application No. 63/589,773, filed on Oct. 12, 2023.

(51) Int. Cl. A45B 11/00; A45B 19/04; A45B 25/24; A61G 5/10

(52) U.S. Cl. CPC A45B 11/00; A45B 19/04; A45B 25/24; A61G 5/10

(57) ABSTRACT

An automatic wheelchair umbrella device is provided. The device is comprised of a housing that can be attached to a wheelchair. The housing stores at least one umbrella. The umbrella can be extended from the housing by pushing a button that can be attached to the wheelchair. Once extended, the umbrella can be retracted back into the housing via the same button. The umbrella may be comprised of a motorized and/or spring-loaded opening and closing mechanism that automatically opens and closes the umbrella once the umbrella is extended from the housing.

### CROSS-REFERENCE TO RELATED APPLICATION

The present application claims priority to, and the benefit of, U.S. Provisional Application No. 63/589,773, which was filed on Oct. 12, 2023, and is incorporated herein by reference in its entirety.

### FIELD OF THE INVENTION

The present invention relates generally to the field of wheelchairs. More specifically, the present invention relates to an automatic wheelchair umbrella device that can be attached to a wheelchair and can be automatically deployed by the user of the wheelchair. Accordingly, the present disclosure makes specific reference thereto. Nonetheless, it is to be appreciated that aspects of the present invention are also equally applicable to other like applications, devices, and methods of manufacture.

### BACKGROUND

Individuals who use wheelchairs often face unique challenges when navigating the outdoors, especially during unpredictable weather conditions wherein they may be more susceptible to the elements than those who can walk without assistance. This vulnerability is exacerbated by the fact that using a wheelchair may require both hands, leaving little or no room to hold and manage an umbrella effectively. For many, trying to maneuver their wheelchair while simultaneously attempting to shield themselves from rain or snow with an umbrella can be a complex and daunting task. This difficulty can make even short trips outside feel like major undertakings, and for some, it may be nearly impossible.

Therefore, there exists a long-felt need in the art for a device that protects a wheelchair user from weather. There also exists a long-felt in the art for an automatic wheelchair umbrella device. More specifically, there exists a long-felt need in the art for an automatic wheelchair umbrella device that can be automatically deployed by a user of a wheelchair in order to protect the user from inclement weather without requiring the user to hold the umbrella. There also exists a long-felt need in the art for an automatic wheelchair umbrella device that can be automatically retracted by a user of a wheelchair when not in use.

The subject matter disclosed and claimed herein, in one embodiment thereof, comprises an automatic wheelchair umbrella device. The device is comprised of a housing that can be attached to a wheelchair. The housing stores at least one umbrella. The umbrella can be extended from the housing by pushing a button that can be attached to the wheelchair. Once extended, the umbrella can be retracted back into the housing via the same button. The umbrella may be comprised of a motorized and/or spring-loaded opening and closing mechanism that automatically opens and closes the umbrella once the umbrella is extended from the housing.

In this manner, the automatic wheelchair umbrella device of the present invention accomplishes all the foregoing objectives and provides a device that protects a wheelchair user from weather in a hands-free manner. More specifically, the device can be automatically deployed by a user of a wheelchair in order to protect the user from inclement weather. Further, the device can be automatically retracted by a user of a wheelchair when not in use.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an automatic wheelchair umbrella device. The device is comprised of a housing that can be attached to a wheelchair via at least one fastener. The housing stores an extendable/retractable umbrella which can be extended from/retracted into the housing via at least one button.

The housing preferably attaches to or near the backrest of the wheelchair via the fastener. At least one umbrella is stored within the housing when the umbrella is not in use. The shaft of the umbrella is preferably fixedly or removably attached to at least one track within the housing. In one embodiment, the track is motorized such that the shaft can be raised from or lowered into the housing along the track to extend or retract the umbrella from/into the housing. The housing is also comprised of at least one lid that attaches to the housing via at least one hinge.

The umbrella is also comprised of at least one opening and closing mechanism. The mechanism may be comprised of a motorized mechanism that automatically opens and locks the umbrella in an open position once the umbrella is extended from the housing. The mechanism then unlocks and closes the umbrella before the umbrella is retracted into the housing. The mechanism may be any motorized opening/closing mechanism. The umbrella can be extended and retracted from the housing as desired via pressing at least one button or other similar control.

The present invention is also comprised of a method of using the device. First, a device is provided comprised of at least one button, a housing comprised of at least one fastener and at least one track, at least one umbrella stored within the housing that attaches to the track, and wherein the umbrella is comprised of an opening/closing mechanism and a body. Then, the housing can be secured to any portion of any style of wheelchair (but preferably to or near the backrest) via the fastener. Then, the button can be secured anywhere on the wheelchair via at least one fastener of the button. Next, the button can be pressed to extend the umbrella from the housing such that the mechanism opens the umbrella and the body of the umbrella covers the user sitting in the wheelchair. Finally, the button can be pressed to retract the umbrella into the housing, and wherein the mechanism first closes the umbrella. In a different embodiment, a user or a secondary user may manually close the umbrella and retract the umbrella into the housing.

Accordingly, the automatic wheelchair umbrella device of the present invention is particularly advantageous as it provides a device that protects a wheelchair user from weather. More specifically, the device can be automatically deployed by a user of a wheelchair in order to protect the user from inclement weather without the need for the user to hold the umbrella. Further, the device can be automatically retracted by a user of a wheelchair when not in use. In this manner, the automatic wheelchair umbrella device provides a hands-free solution to allowing a wheelchair user to use an umbrella.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an automatic wheelchair umbrella device of the present invention while attached to a wheelchair and wherein the umbrella is not deployed in accordance with the disclosed architecture;

FIG. 2 illustrates an enhanced perspective view of one potential embodiment of an automatic wheelchair umbrella device of the present invention wherein the umbrella is not deployed in accordance with the disclosed architecture;

FIG. 3 illustrates a perspective view of one potential embodiment of an automatic wheelchair umbrella device of the present invention while attached to a wheelchair and wherein the umbrella is partially extended from the housing in accordance with the disclosed architecture;

FIG. 4 illustrates a perspective view of one potential embodiment of an automatic wheelchair umbrella device of the present invention while attached to a wheelchair and wherein the umbrella is fully extended from the housing in accordance with the disclosed architecture; and

FIG. 5 illustrates a flowchart of a method of using one potential embodiment of an automatic wheelchair umbrella device of the present invention in accordance with the disclosed architecture.

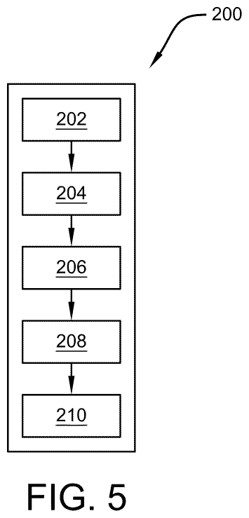

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that protects a wheelchair user from weather. There also exists a long-felt in the art for an automatic wheelchair umbrella device. More specifically, there exists a long-felt need in the art for an automatic wheelchair umbrella device that can be automatically deployed by a user of a wheelchair in order to protect the user from inclement weather without requiring the user to hold the umbrella. There also exists a long-felt need in the art for an automatic wheelchair umbrella device that can be automatically retracted by a user of a wheelchair when not in use.

The present invention, in one exemplary embodiment, is comprised of an automatic wheelchair umbrella device comprised of a housing that can be attached to a wheelchair via at least one fastener. The housing stores an extendable/retractable umbrella which can be extended from/retracted into the housing via at least one button.

The housing preferably attaches to or near the backrest of the wheelchair via the fastener, wherein at least one umbrella is stored within the housing when the umbrella is not in use. The shaft of the umbrella is preferably fixedly or removably attached to at least one track within the housing. In one embodiment, the track is motorized such that the shaft can be raised from or lowered into the housing along the track to extend or retract the umbrella from/into the housing. The housing is also comprised of at least one lid that attaches to the housing via at least one hinge.

The umbrella is also comprised of at least one opening and closing mechanism. The mechanism may be comprised of a motorized mechanism that automatically opens and locks the umbrella in an open position once the umbrella is extended from the housing. The mechanism then unlocks and closes the umbrella before the umbrella is retracted into the housing. The mechanism may be any motorized opening/closing mechanism. The umbrella can be extended and retracted from the housing as desired via pressing at least one button or other similar control.

The present invention is also comprised of a method of using the device. First, a device is provided comprised of at least one button, a housing comprised of at least one fastener and at least one track, at least one umbrella stored within the housing that attaches to the track, and wherein the umbrella is comprised of an opening/closing mechanism and a body. Then, the housing can be secured to any portion of any style of wheelchair (but preferably to or near the backrest) via the fastener. Then, the button can be secured anywhere on the wheelchair via at least one fastener of the button. Next, the button can be pressed to extend the umbrella from the housing such that the mechanism opens the umbrella and the body of the umbrella covers the user sitting in the wheelchair. Finally, the button can be pressed to retract the umbrella into the housing, and wherein the mechanism first closes the umbrella. In a different embodiment, a user or a secondary user may manually close the umbrella and retract the umbrella into the housing.

Accordingly, the automatic wheelchair umbrella device of the present invention is particularly advantageous as it provides a device that protects a wheelchair user from weather. More specifically, the device can be automatically deployed by a user of a wheelchair in order to protect the user from inclement weather without the need for the user to hold the umbrella. Further, the device can be automatically retracted by a user of a wheelchair when not in use. In this manner, the automatic wheelchair umbrella device provides a hands-free solution to allowing a wheelchair user to use an umbrella.

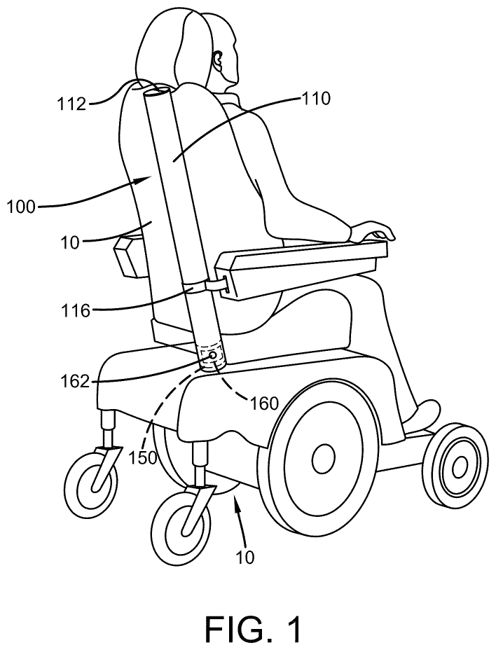

Referring initially to the drawings, FIG. 1 illustrates a perspective view of one potential embodiment of an automatic wheelchair umbrella device 100 of the present invention while attached to a wheelchair and wherein the umbrella 130 is not deployed in accordance with the disclosed architecture. The device 100 is comprised of a housing 110 that can be attached to a wheelchair 10 via at least one fastener 116, wherein the housing 110 stores an extendable/retractable umbrella 130. The umbrella 130 can be extended from/retracted into the housing via at least one button 170 of the device 100. The button 170 can be secured to a portion of the wheelchair 10 via at least one fastener 172.

The housing 110 is preferably cylindrical/tubular in shape but may be any shape, size, and configuration in different embodiments. The housing 110 is preferably made from a waterproof plastic or waterproof/rust-proof metal material. The housing 110 can be attached to any portion of a wheelchair 10 via at least one fastener 116. However, the housing 110 preferably attaches to or near the backrest 12 of the wheelchair via the fastener 116. The fastener 116 may be any type, such as, but not limited to, hook and loop, strap, elastic, magnetic, mounting bracket, suction cup, bolt, screw, tongue, groove, etc.

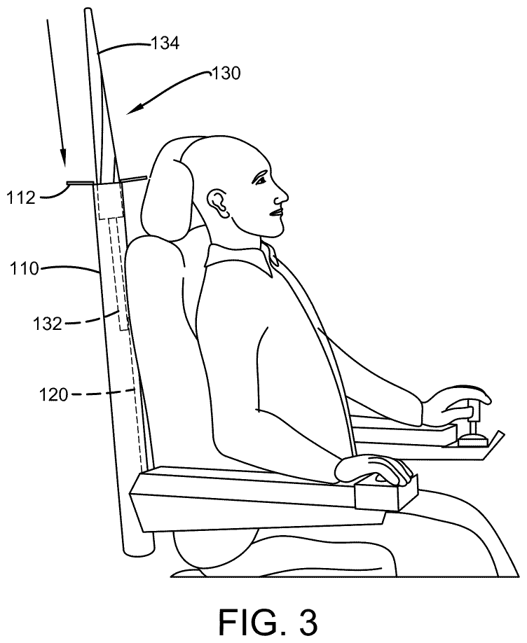

At least one umbrella 130 is stored within the housing 110 when the umbrella 130 is not in use. The shaft 132 of the umbrella 130 is preferably fixedly or removably attached to at least one track 120 within the housing 110. In one embodiment, the track 120 is motorized such that the shaft 132 can be raised from or lowered into the housing 110 along the track 120 to extend or retract the umbrella 130 from/into the housing 110, as seen in FIG. 3.

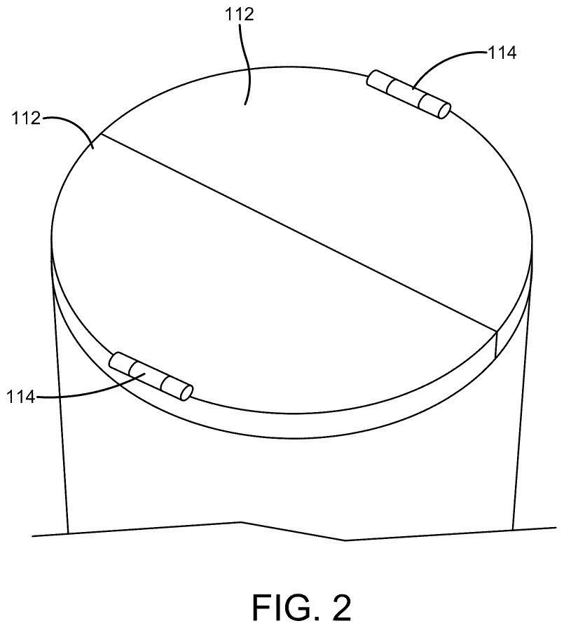

The housing 110 is comprised of at least one lid 112 that attaches to the housing 110 via at least one hinge 114. The hinge 114 may be any type known in the art. The hinge 114 allows the lid 112 to be pushed open to allow the umbrella 130 to extend from the housing 110. In the preferred embodiment, the housing 110 has two half-circular lids 112 that each attach to the housing 110 via at least one hinge 114, as seen in FIG. 2. When the umbrella 130 is extended from the housing 110 the lid 112 may be held open via a portion of the umbrella 130, shaft 132, body 134, etc.

The umbrella 130 may be any style of umbrella known in the art. The umbrella 130 is comprised of a waterproof, fabric body 134 such as, but not limited to, nylon, polyester, cotton, etc. The body 134 may be strengthened by at least one support member 136.

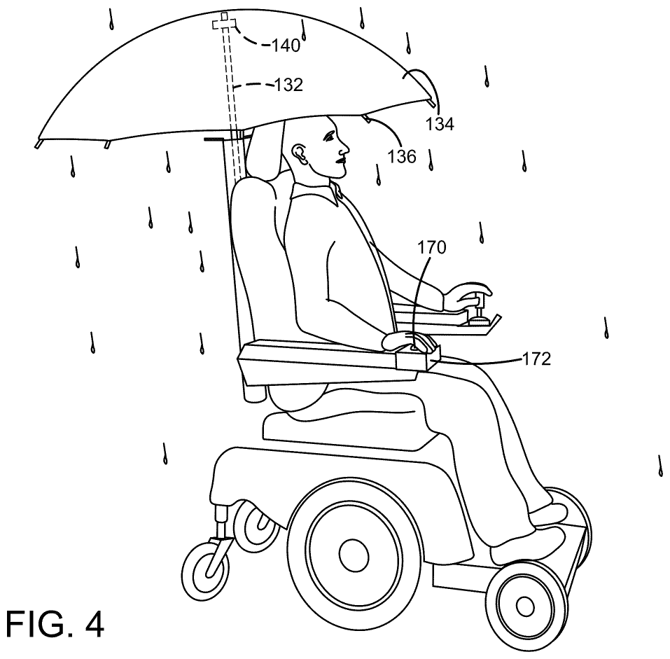

The umbrella 130 is also comprised of at least one opening and closing mechanism 140. The mechanism 140 may be comprised of a motorized mechanism that automatically opens and locks the umbrella 130 in an open position once the umbrella 130 is extended from the housing 110, as seen in FIG. 4. The mechanism 140 then unlocks and closes the umbrella 130 before the umbrella 130 is retracted into the housing 110. The mechanism 140 may be any motorized opening/closing mechanism.

The track 120 and mechanism 140 may be powered by at least one motor 150. The motor 150 is preferably an electric motor. The motor 140 is powered by at least one battery 160. In one embodiment, the battery 160 is removable and may be disposable or rechargeable. In another embodiment, the battery 160 is non-removable and can be recharged via at least one charging port 162. The port 162 may be any type known in the art but is preferably a USB port.

The umbrella 130 can be extended and retracted from the housing 110 as desired via pressing at least one button 170 or other similar control. The button 170 is in wired or wireless communication with the motor 150 such that the button 170 controls the movement of the umbrella 130 along the track 120. The button 170 may attach to any portion of a wheelchair 10 via at least one fastener 172 such as, but not limited to, a magnet, an adhesive fastener, a sleeve, a hook and loop fastener, etc.

In one embodiment, the mechanism 140 and the track 120 are spring-loaded. In this embodiment, pressing the button 170 releases the track 120 such that the umbrella 130 travels upwards and extends from the housing 110 via spring action. Once outside the housing 110, the mechanism 140 is automatically released via spring action which opens the umbrella. The umbrella 130 must then be manually closed and placed back into the housing 110 by a user (or secondary user), thus resetting both the mechanism 140 and track 120 for the next deployment. In one embodiment, the shaft 132 is telescopic and may be spring-loaded such that it deploys the umbrella 130 from the housing 110 via spring-action instead of having a spring-loaded track 120.

The present invention is also comprised of a method of using 200 the device 100, as seen in FIG. 4. First, a device 100 is provided comprised of at least one button 170, a housing 110 comprised of at least one fastener 116 and at least one track 120, at least one umbrella 130 stored within the housing 110 that attaches to the track 120, and wherein the umbrella 130 is comprised of an opening/closing mechanism 140 and a body 134 [Step 202]. Then, the housing 110 can be secured to any portion of any style of wheelchair (but preferably to or near the backrest 10) via the fastener 116 [Step 204]. Then, the button 170 can be secured anywhere on the wheelchair 10 via at least one fastener 172 of the button 170 [Step 206]. Next, the button 170 can be pressed to extend the umbrella 130 from the housing 110 such that the mechanism 140 opens the umbrella 130 and the body 134 of the umbrella 130 covers the user sitting in the wheelchair [Step 208]. Finally, the button 170 can be pressed to retract the umbrella 130 into the housing 110, and wherein the mechanism 140 first closes the umbrella 130 [Step 208]. In a different embodiment, a user or a secondary user may manually close the umbrella 130 and retract the umbrella 130 into the housing 110 [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “automatic wheelchair umbrella device” and “device” are interchangeable and refer to the automatic wheelchair umbrella device 100 of the present invention.

Notwithstanding the foregoing, the automatic wheelchair umbrella device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the automatic wheelchair umbrella device 100 as shown in the FIGS. are for illustrative purposes only, and that many other sizes and shapes of the automatic wheelchair umbrella device 100 are well within the scope of the present disclosure. Although the dimensions of the automatic wheelchair umbrella device 100 are important design parameters for user convenience, the automatic wheelchair umbrella device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An automatic wheelchair umbrella device comprising:
a housing comprised of a first fastener;
an umbrella stored within the housing, the umbrella comprised of an opening and closing mechanism; and
a button comprised of a second fastener.

2. The automatic wheelchair umbrella device of claim 1, wherein the umbrella is comprised of a spring-loaded, telescopic shaft.

3. The automatic wheelchair umbrella device of claim 1, wherein the opening and closing mechanism is comprised of a spring-loaded opening and closing mechanism.

4. The automatic wheelchair umbrella device of claim 1, wherein the second fastener is comprised of a sleeve.

5. The automatic wheelchair umbrella device of claim 1, wherein the first fastener is comprised of a strap.

6. The automatic wheelchair umbrella device of claim 1, wherein the housing is comprised of a lid.

7. The automatic wheelchair umbrella device of claim 6, wherein the lid attaches to the housing via a hinge.

8. An automatic wheelchair umbrella device comprising:
a housing comprised of a first fastener and a lid that attaches to the housing via a hinge;
an umbrella stored within the housing, wherein a shaft of the umbrella is attached to a track within the housing and the umbrella is comprised of an opening and closing mechanism;
a button comprised of a second fastener;
a motor; and
a battery.

9. The automatic wheelchair umbrella device of claim 8, wherein the track is comprised of a motorized track.

10. The automatic wheelchair umbrella device of claim 8, wherein the track is comprised of a spring-loaded track.

11. The automatic wheelchair umbrella device of claim 8, wherein the opening and closing mechanism is comprised of a motorized opening and closing mechanism.

12. The automatic wheelchair umbrella device of claim 8, wherein the button is in electrical communication with the motor.

13. The automatic wheelchair umbrella device of claim 8, wherein the first fastener is comprised of a hook and loop fastener, a strap fastener, an elastic fastener, a magnetic fastener, a mounting bracket fastener, a suction cup fastener, a bolt fastener, a screw fastener, a tongue fastener, or a groove fastener.

14. The automatic wheelchair umbrella device of claim 8, wherein the umbrella is comprised of a body comprised of a support.

15. The automatic wheelchair umbrella device of claim 8, wherein the battery is comprised of a removable battery.

16. The automatic wheelchair umbrella device of claim 8, wherein the battery is comprised of a charging port.

17. The automatic wheelchair umbrella device of claim 9, wherein the button controls movement of the track.

18. The automatic wheelchair umbrella device of claim 8, wherein the body is comprised of a waterproof material.

19. A method of using an automatic wheelchair umbrella device, the method comprising:
providing an automatic wheelchair umbrella device comprised of a button, a housing comprised of a fastener, and an umbrella stored within the housing, the umbrella comprised of a body and an opening and closing mechanism;
securing the housing to a wheelchair via the fastener;
securing the button to the wheelchair via a second fastener;
pressing the button to extend the umbrella from the housing; and
pressing the button to retract the umbrella into the housing.

20. The method of using an automatic wheelchair umbrella device of claim 19, wherein the automatic wheelchair umbrella device is comprised of a motorized track.
